(19) United States
(12) Patent Application Publication
(10) Pub. No.: US 2008/0129764 A1
(43) Pub. Date: Jun. 5, 2008

(54) Method of driving a discharge display panel for effective addressing, driver therefor and display panel using the same

(76) Inventors: Seong-Joon Jeong, Suwon-si (KR); Tae-Seong Kim, Suwon-si (KR); Suk-Jae Park, Suwon-si (KR); Seung-Min Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/984,267

(22) Filed: Nov. 15, 2007

(30) Foreign Application Priority Data
Nov. 21, 2006 (KR) 10-2006-0115458

(51) Int. Cl. G09G 5/10

(52) U.S. Cl. 345/690

(57) ABSTRACT

Driving a display may include dividing a unit frame into a plurality of sub-fields and dividing each of the sub-fields into a reset period, an addressing period, and a discharge-sustaining period. During the addressing period, a voltage difference between an addressing electric potential applied to selected address electrode-lines and a bias electric potential applied to scanning electrode-lines not scanned increases over the addressing period.

### BACKGROUND OF THE INVENTION

1. Field of the Invention

Embodiments relates to a method of driving a discharge display panel, a driver, and a display panel, and more particularly, to a method of driving a discharge display panel, a driver and a display panel in which a unit frame is divided into a plurality of sub-fields and each sub-field includes a reset period, an address period, and a discharge-sustaining period.

2. Description of the Related Art

In a conventional discharge display device, a unit frame may be divided into a plurality of sub-fields for displaying a time ratio gray-scale. Each of the sub-fields may include a reset period, an addressing period, and a discharge-sustaining period. Each of the sub-fields may have its own unique gray-scale weighted value. The discharge-sustaining period of each of the sub-fields may be established in proportion to corresponding gray-scale weighted values of each of the sub-fields.

Operations of the reset, addressing, and discharge-sustaining periods may be sequentially performed in the sub-fields. During the reset period, all discharge cells of the conventional discharge display device may have uniform charge states, such that they are suitable for addressing for the next period. During the addressing period, a predetermined wall electric potential may be generated in the selected discharge cells of the conventional discharge display device. During the discharge-sustaining period, the discharge cells, in which the wall electric potential has been generated during the addressing period, discharge.

During the addressing period, a scan pulse having a negative polarity electric potential lower than a ground electric potential may be sequentially applied to scanning electrode lines of the conventional discharge display device. Therefore, the addressing period may be the longest period during a sub-field and, the higher the resolution of the conventional discharge display panel, the longer the addressing period takes.

Accordingly, for later addressed discharge cells, the charge states resulting from resetting during the reset period may vary, i.e. may not have the uniform charge state established during the reset period, due to a long delay from completion of the reset period until the start of the addressing period. Consequently, a misfiring may occur during the addressing period in later addressed discharge cells.

### SUMMARY OF THE INVENTION

Embodiments of the present invention are therefore directed to a display panel, a driver and a method of driving the display panel, which substantially overcome one or more of the problems due to the limitations and disadvantages of the related art.

It is a feature of an embodiment to provide a display panel, a driver and a method of driving the display panel, in which misfirings during an addressing period are reduced or eliminated.

It is another feature of an embodiment to provide a display panel, a driver and a method of driving the display panel, in which a charge state in later addressed discharge cells is compensated or maintained.

At least one of the above and other feature and advantages may be realized by providing a method of driving a discharge display panel, including dividing a unit frame into a plurality of sub-fields for a time-sharing drive, and dividing each of the sub-fields into a reset period, an addressing period, and a discharge-sustaining period, wherein, during the addressing period, a voltage difference between an addressing electric potential applied to selected address electrode-lines and a bias electric potential applied to scanning electrode-lines increases over the addressing period.

During the addressing period, the bias electric potential may be applied to the scanning electrode-lines and addressing electric potential applied to the selected address electrode-lines may be constant.

The addressing period may be divided into at least two sub-periods so that the bias electric potential varies in a step form.

During the addressing period, a falling time of the scan pulse that is applied sequentially to the scanning electrode-lines may decrease over the addressing period, a rising time of a scan pulse applied sequentially to the scanning electrode-lines may decrease over the addressing period, and a total actual time during which a scan pulse is applied may be constant.

During the addressing period, a time during which a maximum scan pulse voltage is applied may increase over the addressing period.

The addressing period may be divided into n sub-periods so that the bias electric potential may decrease from V_{SCH1} to V_{SCHn}. A voltage difference between sub-periods is constant and the n sub-periods equally divide the addressing period.

During the addressing period, a negative voltage to sustain electrode-lines formed alternately with the scanning electrode-lines may be applied.

At least one of the above and other feature and advantages may be realized by providing a driver for a discharge display panel, including a frame divider adapted to divide a unit frame into a plurality of subfields, a subfield divider adapted to divide each subfield into a reset period, an addressing period, and a discharge-sustaining period, and a driving unit adapted to increase a voltage difference between an addressing electric potential applied to selected address electrode-lines and a bias electric potential applied to scanning electrode-lines over the addressing period.

At least one of the above and other feature and advantages may be realized by providing a display panel including the driver.

### BRIEF DESCRIPTION OF THE DRAWINGS

The above and other features and advantages of the present invention will become more apparent by describing in detail exemplary embodiments thereof with reference to the attached drawings, in which:

FIG. 1 illustrates an exploded perspective view of a three-electrode surface discharge type plasma display panel (PDP) operating as a discharge display panel according to an embodiment;

FIG. 2 illustrates a cross-sectional view of a discharge cell of the PDP illustrated in FIG. 1, according to an embodiment;

FIG. 3 illustrates a block diagram of an apparatus for driving the PDP illustrated in FIG. 1, according to an embodiment;

FIG. 4 illustrates a timing diagram of a method for driving the PDP illustrated in FIG. 1 using the driving apparatus of FIG. 3, according to an embodiment;

FIG. 5 illustrates a waveform diagram of driving signals used in a sub-field (SF) of the timing diagram of FIG. 4, according to an embodiment;

FIG. 6 illustrates a waveform diagram detailing waveform changes of a scan pulse during an addressing period of the SF of FIG. 5, according to an embodiment;

FIG. 7 illustrates a cross-sectional diagram of a wall charge distribution of one of the discharge cells of the PDP at time t5 of the waveform diagram illustrated in FIG. 5, according to an embodiment;

FIG. 8 illustrates a cross-sectional diagram of a wall charge distribution of one of the discharge cells of the PDP at time t8 of the waveform diagram illustrated in FIG. 5, according to an embodiment;

FIG. 9 illustrates a cross-sectional diagram of a wall charge distribution after an addressing discharge with respect to one of the discharge cells selected during the addressing period of the waveform of FIG. 5, according to an embodiment; and

FIG. 10 illustrates a waveform diagram of driving signals used in each of the sub-fields (SF) of FIG. 4.

### DETAILED DESCRIPTION OF THE INVENTION

Korean Patent Application No. 10-2006-0115458, filed on Nov. 21, 2006, in the Korean Intellectual Property Office, and entitled: “Method of Driving Discharge Display Panel For Effective Addressing,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by ultraviolet light that impinges thereon, and is not intended be limited to materials the undergo light emission through any particular mechanism or over any particular time frame. Like reference numerals refer to like elements throughout.

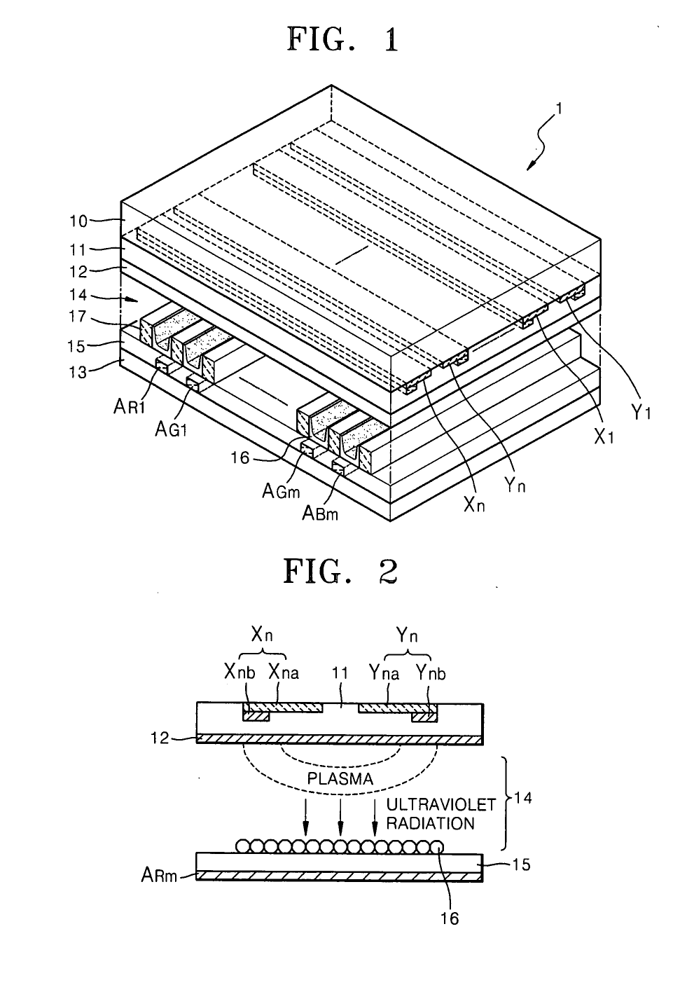

FIG. 1 illustrates an exploded perspective view of a three-electrodes surface discharge type plasma display panel (PDP) 1 operating as a discharge display panel, according to an embodiment of the present invention, and FIG. 2 illustrates a cross-sectional view of a discharge cell of the PDP 1 illustrated in FIG. 1, according to an embodiment of the present invention.

Referring to FIGS. 1 and 2, the three-electrode surface discharge type PDP 1 may include address electrode-lines A_{R1} through A_{Bm}, dielectric layers 11 and 15, X electrode-lines X₁ through Xₙ that serve as sustain electrode-lines, Y electrode-lines Y₁ through Yₙ that serve as scanning electrode-lines, phosphor layers 16, barrier ribs 17, and a protection layer 12 between facing front and rear substrates 10 and 13.

The address electrode-lines A_{R1} through A_{Bm} may be formed in a predetermined pattern on the rear substrate 13. The lower dielectric layer 15 may cover the address electrode-lines A_{R1} through A_{Bm}. The barrier ribs 17 may be formed parallel to the address electrode-lines A_{R1} through A_{Bm} on the lower dielectric layer 15. The barrier ribs 17 may partition discharge spaces of the respective discharge cell and may prevent optical cross talk between the discharge cells. The phosphor layers 16 may be interposed between the barrier ribs 17.

The X electrode-lines X₁ through Xₙ and the Y electrode-lines Y₁ through Yₙ may be alternately and uniformly formed on the rear surface of the front substrate 10 and may intersect the address electrode-lines A_{R1} through A_{Bm}. Each intersecting point may define corresponding discharge cells. Each of the X electrode-lines X₁ through Xₙ and the Y electrode-line Y₁ through Yₙ may include transparent electrode-lines Xₙₐ and Yₙₐ formed of a transparent conductive material, e.g., indium tin oxide (ITO), respectively electrically coupled with opaque, e.g., metal, electrode-lines X_{nb} and Y_{nb} so as to increase conductivity. The front dielectric layer 11 may entirely cover the rear of the X electrode-lines X₁ through Xₙ and the Y electrode-lines Y₁ through Yₙ. The protection layer 12 may protect the PDP 1 from a strong electric field, may be entirely formed on the rear surface of the front dielectric layer 11, and may be, e.g., an MgO layer. A discharge gas may fill the discharge spaces 14.

In the method of driving the PDP, operations of reset, addressing, and discharge-sustaining periods may be sequentially performed in a unit sub-field (SF). After the reset period, all discharge cells may have uniform charge states, and are thus adjusted to be suitable for addressing during the addressing period. During the addressing period, a predetermined wall electric potential may be generated in the selected discharge cells. During the discharge-sustaining period, a predetermined AC voltage may be applied to the X electrode-lines X₁ through Xₙ and Y electrode-lines Y₁ through Yₙ, and thus, the selected discharge cells, in which the wall electric potential was generated during the addressing period, may discharge.

When the AC voltage is supplied to the selected discharge cells, the discharge gas in the discharge spaces 14 of the selected discharge cells may discharge, emitting ultraviolet (UV) light, thereby exciting the phosphor to emit visible light, thus forming an image.

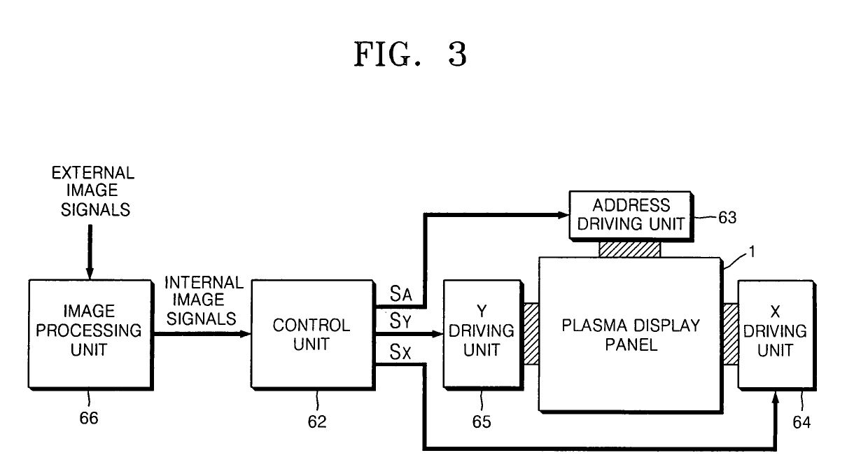

FIG. 3 illustrates a block diagram of an apparatus for driving the PDP 1 illustrated in FIG. 1, according to an embodiment of the present invention.

Referring to FIG. 3, the apparatus for driving the PDP 1 may include an image processing unit 66, a control unit 62, an address driving unit 63, an X driving unit 64, and a Y driving unit 65.

The image processing unit 66 may convert external analog image signals into digital signals so as to generate internal image signals, e.g., 8 bit red (R), green (G), and blue (B) image data, clock signals, and vertical and horizontal sync signals.

The control unit 62 may generate driving control signals S_{A}, S_{Y}, and S_{X} according to the internal image signals of the image processing unit 66.

The address driving unit 63 may process the driving control signal S_{A} to generate a display data signal and to apply the display data signal to the address electrode-lines A_{R1} through A_{Bm}. The X driving unit 64 may process the driving control signal S_{X} to operate the X electrode-lines X₁ through Xₙ. The Y driving unit 65 may process driving control signal to operate the Y electrode-lines Y₁ through Yₙ.

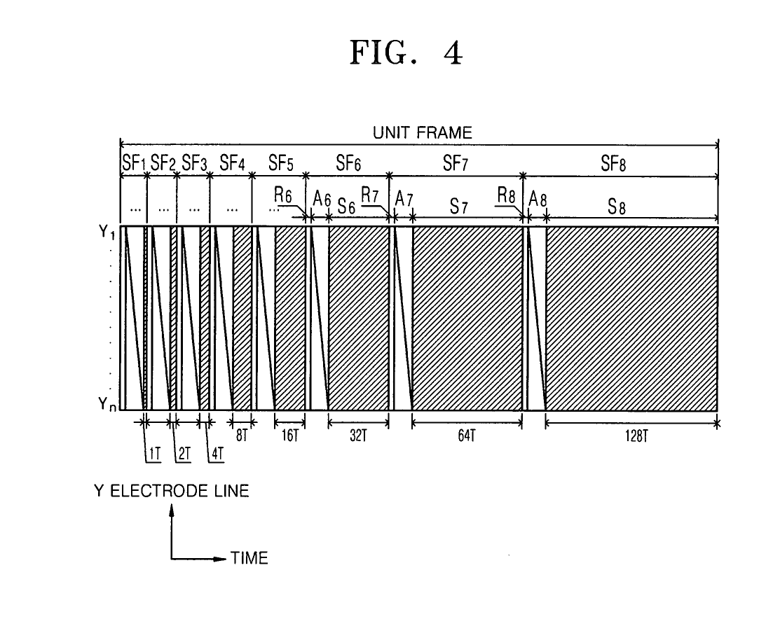

FIG. 4 illustrates a timing diagram of a method of driving the PDP 1 illustrated in FIG. 1 using the driving apparatus of FIG. 3, according to an embodiment of the present invention.

Referring to FIG. 4, in order to realize a time ratio gray-scale display, a unit frame may be divided, e.g., into eight sub-fields SF1 through SF8 sequentially from the lowest gray-scale weighted value to the highest gray-scale weighted value. In addition, each of the sub-fields SF1 through SF8 may be divided into reset periods R1 through R8, addressing periods A1 through A8, and discharge-sustaining periods S1 through S8.

In each of the reset periods R1 through R8, discharge conditions for all discharge cells may be uniform so that the discharge cells are suitable for addressing in the next period.

In each of the addressing periods A1 through A8, a display data signal may be applied to the address electrode-lines A_{R1} through A_{Bm} and a scan pulse may be sequentially applied to each of the Y electrodes-lines Y1 through Yn. Accordingly, when a high display data signal is applied to the address electrode-lines A_{R1} through A_{Bm} while the scan pulse corresponding to each of the Y electrodes-lines Y1 through Yn is applied, wall charges are formed in the corresponding discharge cells due to an addressing discharge. Otherwise, wall charges are not formed in the corresponding discharge cells.

During each of the discharge-sustaining periods S1 through S8, a sustain pulse may be alternately applied to the Y electrodes-lines Y1 through Yn and the X electrode-lines X₁ through Xₙ and thus, a display discharge may occur in the discharge cells in which wall charges are formed during each of the addressing periods A1 through A8. Accordingly, the brightness of the PDP may be proportional to the duration of the discharge-sustaining periods S1 through S8 occupying the unit frame. The duration of the discharge-sustaining periods S1 through S8 occupying the unit frame may be 255 T, where T is a unit period. Therefore, the discharge-sustaining periods may be displayed as 256 gray-scales, including the case that the discharge-sustaining period is not displayed even once in the unit frame.

In the present embodiment, the period 1 T corresponding to 2⁰, the period 2 T corresponding to 2¹, the period 4 T corresponding to 2², the period 8 T corresponding to 2³, the period 16 T corresponding to 2⁴, the period 32 T corresponding to 2⁵, the period 64 T corresponding to 2⁶, and the period 128 T corresponding to 2⁷ may be set in a first sub-field SF₁ during the discharge-sustaining period S₁, a second sub-field SF₂ during the discharge-sustaining period S₂, a third sub-field SF₃ during the discharge-sustaining period S₃, a fourth sub-field SF₄ during the discharge-sustaining period S₄, a fifth sub-field SF₅ during the discharge-sustaining period S₅, a sixth sub-field SF₆ during the discharge-sustaining period S₆, a seventh sub-field SF₇ during the discharge-sustaining period S₇, and an eighth sub-field SF₈ during the discharge-sustaining period S₈, respectively.

Accordingly, if a sub-field that is to be displayed is selected appropriately from the eight sub-fields SF₁ through SF₈, the display of all 256 gray-scales, including a 0 gray-scale that is not displayed in any sub-field, may be performed.

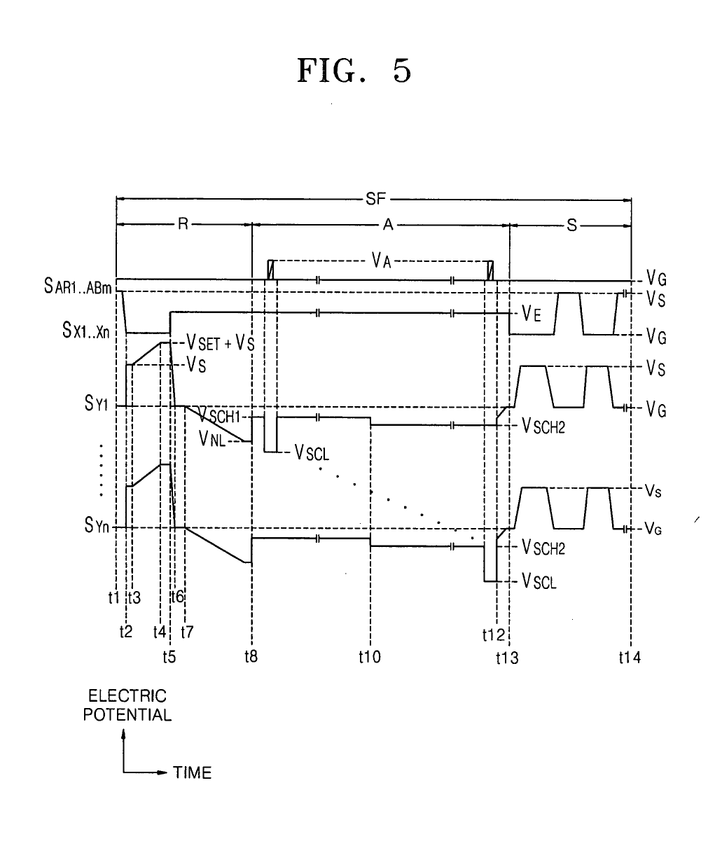

FIG. 5 illustrates a waveform diagram of driving signals used in a sub-field (SF) from among the eight sub-fields SF1 through SF8 of FIG. 4, according to an embodiment of the present invention.

In FIG. 5, driving signals S_{AR1} through S_{ABm} may be applied to each of the address electrode-lines A_{R1} through A_{Bm}. Driving signals S_{X1} through S_{Xn} may be applied to the X electrode-lines X1 through Xn. Driving signals S_{Y1} through S_{Yn} may be applied to the Y electrode-lines Y₁ through Yₙ.

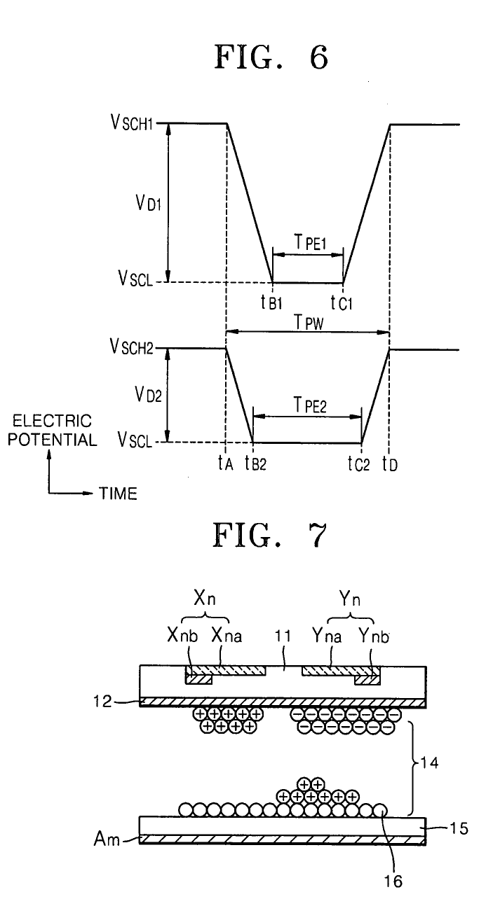

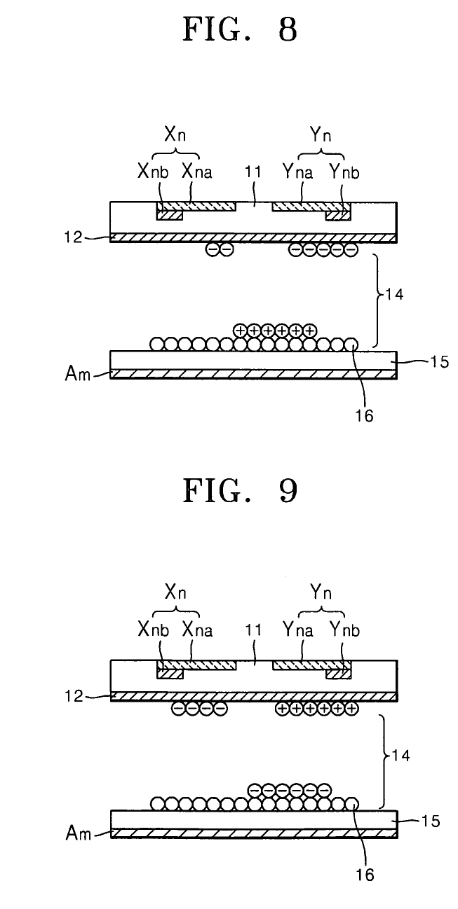

FIG. 6 illustrates a detailed waveform of the scan pulse of driving signals S_{Y1}, through S_{Yn} during an addressing period A of the SF of FIG. 5, according to an embodiment of the present invention. FIG. 7 illustrates a cross-sectional diagram of a wall charge distribution of one of the discharge cells at time t₅ of the SF illustrated in FIG. 5, according to an embodiment of the present invention. FIG. 8 illustrates a cross-sectional diagram of a wall charge distribution of one of discharge cells at time t₈ of the SF illustrated in FIG. 5, according to an embodiment of the present invention. FIG. 9 illustrates a cross-sectional diagram of a wall charge distribution after an addressing discharge with respect to one of the discharge cells selected during the addressing period A of the SF of FIG. 5, according to an embodiment of the present invention. In FIGS. 7 through 9, the same labels as those of FIG. 2 refer to elements having the same functions.

Referring to FIG. 5, during a first electric potential raising period t1 through t5 during the reset period R of the sub-field SF, an electric potential having a positive polarity applied to the Y electrode-lines Y₁ through Yₙ may rise from a ground voltage V_{G} to a first electric potential V_{SET}+V_{S}, which may be higher than a fourth electric potential V_{S} by a ninth electric potential V_{SET}, for example, 355 volts (V).

The ground voltage V_{G} may be applied to the X electrode-lines X₁ through Xₙ and the address electrode-lines A_{R1} through A_{Bm} during the first electric potential raising period t1 through t5.

Accordingly, a discharge may occur between the Y electrode-lines Y₁ through Yₙ and the X electrode-lines X₁ through Xₙ and between the Y electrode-lines Y₁ through Yₙ and the address electrode-lines A_{R1} through A_{Bm}. Therefore, wall charges with a negative polarity may be formed near the Y electrode-lines Y₁ through Yₙ, wall charges with a positive polarity may be formed near the X electrode-lines X₁ through Xₙ, and wall charges with a positive polarity may be formed near the address electrode-lines A_{R1} through A_{Bm} (refer to FIG. 7).

Then, during a electric potential falling period t5 through t8 during the reset period R of the sub-field SF, while a fifth electric potential V_{E} may be constantly applied to the X electrode-lines X₁ through Xₙ, the electric potential that is applied to the Y electrode-lines Y₁ through Yₙ may fall from the first electric potential V_{SET}+V_{S} to a second electric potential V_{NL} with a negative polarity. In the present embodiment, the ground voltage V_{G} may be applied to the address electrode-lines A_{R1} through A_{Bm}. Accordingly, due to discharge occurring between the X electrode-lines X₁ through Xₙ and the Y electrode-lines Y₁ through Yₙ, some of the wall charges with a negative polarity near the Y electrode-lines Y₁ through Yₙ may move closer to the X electrode-lines X₁ through Xₙ (refer to FIG. 8). In addition, since the ground voltage V_{G} is applied to the address electrode-lines A_{R1} through A_{Bm} during the reset period R, the number of wall charges with a positive polarity formed around the address electrode-lines A_{R1} through A_{Bm} may decrease (refer to FIG. 8).

During all of the addressing period A, the fifth electric potential V_{E} with a positive polarity may be applied to the X electrode-lines X₁ through Xₙ.

During the first half of the addressing period A, i.e., a period t8 through t10 of the sub-field SF, a display data signal may be applied to the address electrode-lines A_{R1} through A_{Bm} and a scan pulse of a seventh electric potential V_{SCL} with a negative polarity may be sequentially applied to the Y electrode-lines Y₁ through Yₙ biased to a sixth electric potential V_{SCH1} with a negative polarity, such that address discharge occurs. The display data signal may be applied to each of the address electrode-lines A_{R1} through A_{Bm} as an eighth electric potential V_{A} with a positive polarity when the discharge cell is selected and as the ground voltage V_{G} when the discharge cell is not selected. Therefore, while the eighth electric potential V_{A} with a positive polarity is applied and the scan pulse of the seventh electric potential V_{SCL} with a negative polarity is applied, a wall charge state for sustain discharge may be formed due to address discharge in the corresponding discharge cells (refer to FIG. 9).

During the second half of the address period A, i.e., a period t10 through t13, a display data signal may be applied to the address electrode-lines A_{R1} through A_{Bm} and the scan pulse of the seventh electric potential V_{SCL} with a negative polarity may be sequentially applied to the Y electrode-lines Y₁ through Yₙ biased to a third electric potential V_{SCH2} with a negative polarity having a larger absolute value than the sixth electric potential V_{SCH1} with a negative polarity, such that address discharge occurs. The display data signal applied to each address electrode-line A_{R1} through A_{Bm} as an eighth electric potential V_{A} with a positive polarity when the discharge cell is selected and as the ground voltage V_{G} when the discharge cell is selected. Therefore, while the eighth electric potential V_{A} with a positive polarity is applied to the address electrode-lines A_{R1} through A_{Bm} and the scan pulse of the seventh electric potential V_{SCL} with a negative polarity is applied to the Y electrode-lines Y₁ through Yₙ, a wall charge state for sustain discharge may be formed due to address discharge in the corresponding discharge cells (refer to FIG. 9).

During the discharge-sustaining period S of the SF, a sustain pulse of a fourth electric potential V_{S} with a positive polarity may be alternately applied to the Y electrode-lines Y₁ through Yₙ and X electrode-lines X₁ through Xₙ, thus sustain discharge may occur in the discharge cells selected during the corresponding addressing period A.

As described above, during the addressing period A of the SF, a voltage difference between the addressing eighth electric potential V_{A} applied to the selected address electrode-lines A_{R1} through A_{Bm} and the biased sixth or third electric potential V_{SCH1} or V_{SCH2} applied to the Y electrode-lines Y₁ through Yₙ, that are not scanned, may increase as time passes, i.e., over the addressing period A.

Therefore, during the time that each discharge cell waits for the start of addressing from completion time t8 of the reset period R, a voltage difference between the addressing eighth electric potential V_{A} applied to the selected address electrode-lines A_{R1} through A_{Bm} for addressing and the bias sixth or third electric potential V_{SCH1} or V_{SCH2} applied to scanning electrode-lines may relatively increase. Consequently, charge states in later addressed discharge cells may maintained, i.e. may more closely approximate the charge state of the earlier addressed discharge cells, i.e., the state of the discharge cells at the end of the reset period.

In addition, for later addressed discharge cells, the falling time and rising time of the scan pulse of the seventh electric potential V_{SCL} applied sequentially to the Y electrode-lines Y₁ through Yₙ, which act as scanning electrode-lines, may decrease over the addressing period A.

Referring to FIG. 6, the falling time of the scan pulse of the seventh electric potential V_{SCL} applied sequentially to the Y electrode-lines Y₁ through Yₙ may be shortened from t_{A}˜t_{B1} to t_{A}˜t_{B2} for later addressed discharge cells. In addition, the rising time of the scan pulse of the seventh electric potential V_{SCL} applied sequentially to the Y electrode-lines Y₁ through Yₙ may be shortened from t_{C1}˜t_{D} to t_{C2}˜t_{D} for later addressed discharge cells.

In other words, even while a total time during which the scan pulse of the seventh electric potential V_{SCL} (t_{A}˜t_{D}) may be applied is constant, an actual time within that total time that the seventh electric potential V_{SCL} are applied may increase over the addressing period A. In FIG. 6, the actual time during which the seventh electric potential V_{SCL} is applied may increase from T_{PE1} to T_{PE2}.

Therefore, for later addressed discharge cells, even when charge states resulting from resetting during the reset period are altered while the discharge cell waits for the start of addressing from completion time t8 of the reset period R, addressing discharge may occur normally. Consequently, misfirings during the addressing period A may be reduced or eliminated.

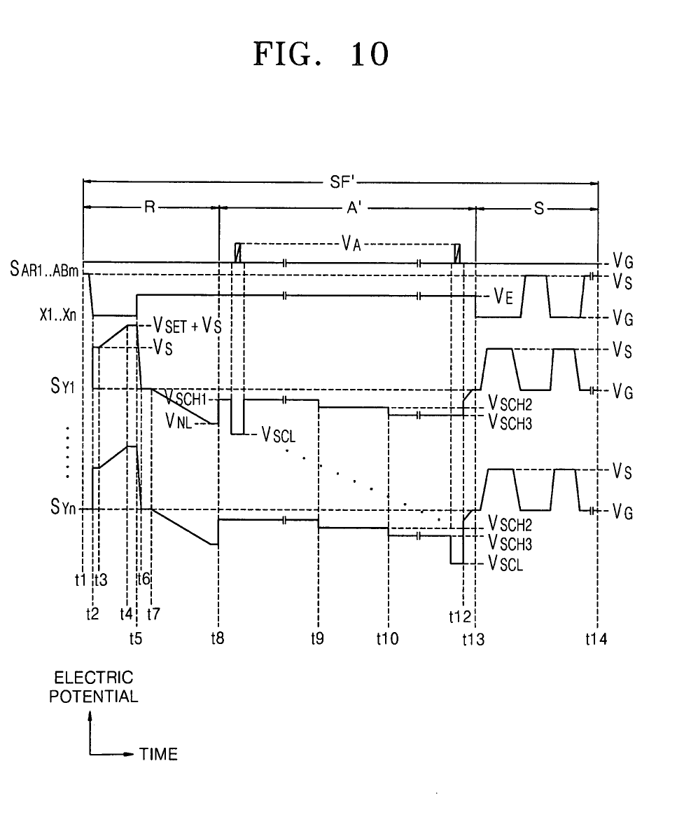

FIG. 10 illustrates a waveform diagram of other driving signals used in a sub-field (SF′) from among the eight sub-fields SF1 through SF8 of FIG. 4, according to another embodiment of the present invention. In FIG. 10, the same labels with those of FIG. 5 refer to elements having the same functions. The reset period R and the discharge-sustaining period S of the SF′ are the same with those of the SF of FIG. 5 and thus, a description thereof is omitted herein. Again, throughout an addressing period A′, the fifth electric potential V_{E} with a positive polarity may be applied to the X electrode-lines X₁ through Xₙ.

Referring to FIG. 10, during a first period t8 through t9 during the addressing period A′ of the SF′, a display data signal may be applied to the address electrode-lines A_{R1} through A_{Bm} and a scan pulse of the seventh electric potential V_{SCL} with a negative polarity may be sequentially applied to the Y electrode-lines Y₁ through Yₙ biased to the sixth electric potential V_{SCH1} with a negative polarity, such that addressing discharge occurs. When the display data signal is applied to each of the address electrode-lines AR₁ through A_{Bm}, the eighth electric potential V_{A} with a positive polarity may be applied when a discharge cell is selected and the ground voltage V_{G} may be applied when a discharge cell is not selected. Therefore, while the eighth electric potential V_{A} with a positive polarity is applied to the address electrode-lines A_{R1} through A_{Bm} and the scan pulse of a seventh electric potential V_{SCL} with a negative polarity is applied to the Y electrode-lines Y₁ through Yₙ biased to the sixth electric potential V_{SCH1}, a wall charge state for sustain discharge may be formed due to address discharge in the corresponding discharge cells (refer to FIG. 9).

During a second period t9 through t10 during the addressing period A′ of the SF′, a display data signal may be applied to the address electrode-lines A_{R1} through A_{Bm} and the scan pulse of the seventh electric potential V_{SCL} with a negative polarity may be sequentially applied to the Y electrode-lines Y₁ through Yₙ biased to the third electric potential V_{SCH2} with a negative polarity having a larger absolute value than the sixth electric potential V_{SCH1} with a negative polarity, such that addressing discharge occurs. When the display data signal is applied to each of the address electrode-lines A_{R1} through A_{Bm}, the eighth electric potential V_{A} with a positive polarity may be applied when the discharge cell is selected and the ground voltage V_{G} may be applied when the discharge cell is not selected. Therefore, while the eighth electric potential V_{A} with a positive polarity is applied and the scan pulse of the seventh electric potential V_{SCL} with a negative polarity is applied, a wall charge state for sustain discharge may be formed due to address discharge in the corresponding discharge cells (refer to FIG. 9).

In the third period t10 through t13 during the addressing period A′ of the SF′, a display data signal may be applied to the address electrode-lines A_{R1} through A_{Bm} and the scan pulse of the seventh electric potential V_{SCL} with a negative polarity may be sequentially applied to the Y electrode-lines Y₁ through Yₙ biased to a ninth electric potential V_{SCH3} with a negative polarity having a larger absolute value than the third electric potential V_{SCH2} with a negative polarity, such that addressing discharge occurs. When the display data signal is applied to each of the address electrode-lines A_{R1} through A_{Bm}, the eighth electric potential V_{A} with a positive polarity may be applied when the discharge cell is selected and the ground voltage V_{G} may be applied when the discharge cell is not selected. Therefore, while the eighth electric potential V_{A} with a positive polarity is applied to the address electrode-lines A_{R1} through A_{Bm} and the scan pulse of the seventh electric potential V_{SCL} with a negative polarity is applied to the Y electrode-lines Y₁ through Yₙ, a wall charge state for sustain discharge may be formed due to address discharge in the corresponding discharge cells (refer to FIG. 9).

As described above, during the addressing period A′ of the SF′, a voltage difference between the addressing eighth electric potential V_{A} applied to the selected address electrode-lines A_{R1} through A_{Bm} and the biased sixth, third, or ninth electric potential V_{SCH1}, V_{SCH2}, or V_{SCH3} applied to the Y electrode-lines Y₁ through Y₁ that are not scanned may increase with time.

Therefore, during the time that each discharge cell waits for the start of addressing from completion time t8 of the reset period R, a voltage difference between the addressing eighth electric potential V_{A} applied to the selected address electrode-lines A_{R1} through A_{Bm} and the biased sixth, third, or ninth electric potential V_{SCH1}, V_{SCH2}, or V_{SCH3} applied to scanning electrode-lines Y electrode-lines may increase. Consequently, for later addressed discharge cells, due to a voltage that is applied while each discharge cell waits for the start of addressing from completion time t8 of the reset period R, charge states resulting from resetting during the reset period may be more closely maintained.

In addition, for later addressed discharge cells, the falling time and rising time of the scan pulse of the seventh electric potential V_{SCL} applied sequentially to the Y electrode-lines Y₁ through Yₙ, may decrease. In other words, even when the total time during which the scan pulse (t_{A}˜t_{D} of FIG. 6) is applied is constant, the actual time during which the seventh electric potential V_{SCL} is applied may increase with time for later addressed discharge cells.

Therefore, for later addressed discharge cells, even when the charge states resulting from resetting during the reset period varies while each discharge cell waits for the start of addressing from the completion of the reset period R, address discharge may occur normally. Consequently, misfirings during the addressing period A may be eliminated or decreased.

As described above, during the time that each discharge cell waits for the start of addressing from the completion of the reset period, a voltage difference between the addressing eighth electric potential V_{A} applied to the selected address electrode-lines A_{R1} through A_{Bm} and the biased sixth, third, or ninth electric potential V_{SCH1}, V_{SCH2}, or V_{SCH3} applied to scanning Y electrode-lines Y₁ through Y₁ may increase with time. Therefore, for later addressed discharge cells, due to a bias voltage applied while each discharge cell waits for the start of addressing from the completion of the reset period, charge states resulting from resetting during the reset period may be maintained.

In addition, for later addressed discharge cells, the falling time and rising time of the scan pulse applied sequentially to the scanning electrode-lines may decrease with time. In other words, even when the total time during which the scan pulse is applied constant, the actual time during which a peak voltage of the scan pulse is applied may increase with time. Therefore, for later addressed discharge cells, even when charge states resulting from resetting during the reset period have varied, i.e., are somewhat non-uniform, while each discharge cell waits for the start of addressing from the completion of the reset period R, addressing discharge may occur normally.

Consequently, misfirings during the addressing period may be decreased or eliminated according to embodiments.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of driving a discharge display panel, comprising:
dividing a unit frame into a plurality of sub-fields for a time-sharing drive; and
dividing each of the sub-fields into a reset period, an addressing period, and a discharge-sustaining period,
wherein, during the addressing period, a voltage difference between an addressing electric potential applied to selected address electrode-lines and a bias electric potential applied to scanning electrode-lines increases over the addressing period.

2. The method as claimed in claim 1, further comprising, during the addressing period, varying the bias electric potential applied to the scanning electrode-lines.

3. The method as claimed in claim 2, wherein the addressing period is divided into at least two sub-periods so that the bias electric potential varies in a step form.

4. The method as claimed in claim 2, wherein during the addressing period, a falling time of the scan pulse that is applied sequentially to the scanning electrode-lines decreases over the addressing period.

5. The method as claimed in claim 2, wherein during the addressing period, a rising time of a scan pulse applied sequentially to the scanning electrode-lines decreases over the addressing period.

6. The method as claimed in claim 2, wherein during the addressing period, a total actual time during which a scan pulse is applied is constant.

7. The method as claimed in claim 6, wherein during the addressing period, a time during which a maximum scan pulse voltage is applied increases over the addressing period.

8. The method as claimed in claim 2, wherein the addressing period is divided into n sub-periods so that the bias electric potential may decrease from V_{SCH1} to V_{SCHn}.

9. The method as claimed in claim 8, wherein a voltage difference between sub-periods is constant and the n sub-periods equally divide the addressing period.

10. The method as claimed in claim 2, further comprising maintaining the addressing electric potential applied to the selected address electrode-lines to be constant.

11. The method as claimed in claim 1, further comprising, during the addressing period, applying a negative voltage to sustain electrode-lines formed alternately with the scanning electrode-lines.
